(19) United States
(12) Patent Application Publication
(10) Pub. No.: US 2017/0067515 A1
(43) Pub. Date: Mar. 9, 2017

(54) Ball hydraulic Clutch

(71) Applicant: Scripcariu Ion, Uzun Village (RO)

(72) Inventor: Scripcariu Ion, Uzun Village (RO)

(21) Appl. No.: 14/756,369

(22) Filed: Sep. 3, 2015

(51) Int. Cl. F16D 25/12; B60K 25/00

(52) U.S. Cl. CPC F16D 25/12; B60K 25/00

(57) ABSTRACT

This invention refers to a hydraulic bearing clutch which is placed between the engine and the gear box, being suitable for any type of gear box. The hydraulic bearing clutch, according to this invention includes: a metal disc (1) coupled with an engine flywheel (2), a PTO shaft (3) attached to the metal disc (1) and tied in with a rotor (8) of the hydraulic pump (4) and a pressure chamber (7) mounted on the PTO shaft (3). Inside the hydraulic pump (4) there is a ball drum (9) tied in with the rotor (8) of the pump and in gear, through blocking, with the stator (15) of the pump. The stator is tied in with the primary shaft (6) on which are mounted a low pressure chamber (33) and a high pressure chamber (28). The high pressure chamber (28) is connected to a pressure regulator (38) and, through a solenoid valve (37), to the pressure chamber (7) on the PTO shaft (3). The pump rotor (8) has provided some radial rectangular seats (29) into which slide some metal blades (14), connected with an axial groove (11) and a radial groove (10) which correspond to the pressure chamber (7) on the PTO shaft (3). The axial groove (11) corresponds to a circular groove (17) and to the radial grooves (18) on the drum (9) and some balls (20) press on a circular groove (21) with bulges on the stator (15). The stator (15) is provided with admission ports (23), corresponding to the cross grooves (25) and the radial grooves (26), but also to the axial grooves (27) on the primary shaft (6). These grooves also make the connection with the high pressure chamber (28) and the low pressure chamber (33).

This invention refers to a ball hydraulic clutch which is located between the engine and the gearbox, and is intended for any type of gearbox.

Mechanical clutches are used for the engaging and disengaging the power transmission from the engine to the gears; in mechanical clutches the power is transmitted through the friction discs.

The disadvantage of these discs consists in the fact that they wear in time.

In hydraulic clutches the power is transmitted via bladed wheels located in a fluid.

The disadvantages of these hydraulic clutches are generated by the slides between the clutch parts and the delays in their coupling.

There are also electromagnetic clutches which use for coupling a magnetic fluid which subjected to a potential difference.

The disadvantage of this type of clutch is the constant consumption of electricity required in order to maintain an electric field.

All these types of clutches are heavy and large in volume, and some are very complex to build.

The technical problem solved by this invention is the creation of a clutch with multiple destinations which should allow the progressive engaging and disengaging of the gears; assure, when engaged stage, the perfect coupling between the engine and the transmission; and achieve integrally the maximum torque of the engine without slippage.

The ball hydraulic clutch, according to this invention, offers a solution to the disadvantages mentioned above since it is made up of a metal disc coupled with a flywheel of the engine, a power take-off (PTO) shaft coupled with the metal disc and tied in with a rotor of the hydraulic pump, and a pressure chamber mounted on the PTO shaft. Inside the hydraulic pump there is a drum with balls which is tied in with the rotor of the pump and in gear, through blocking, with the stator which is tied in with the primary shaft on which are mounted a low pressure chamber and a high pressure chamber. The high pressure chamber is connected with a pressure regulator and, through a solenoid valve, to the pressure chamber on the PTO shaft. In its turn, the pressure regulator is connected to an oil cooling radiator which is connected to the low pressure chamber. The rotor of the pump is provided with radial rectangular seats into which slide some metal blades, and radial grooves which are in connection with an axial groove and a radial groove corresponding to the pressure chamber on the PTO shaft. The axial groove corresponds to a circular groove and to radial grooves on the drum. A number of balls press on a circular groove with bulges on the stator. The stator has a number of admission ports which correspond to some transverse grooves and radial grooves, but also with some axial grooves on the primary shaft. These grooves make the connection with the high pressure and low pressure chambers. The stator is fitted on the outside with a threaded section on which a threaded securing ring is fitted which regulates the distance between the rotor and the stator, as well as the tightening of the bearings which are located inside the hydraulic pump.

The ball hydraulic clutch, according to the invention, has the following advantages:
it assures the progressive coupling of the engine with the transmission;
it allows the heat generated during the pressure regulator closing to be eliminated;
it has a long service duration and high resistance;
it has a low weight;
through its configuration it ensures a very good safety in operation;
it doesn't have a complex construction;
the basic parameters remain the same during the operation;
is transmits the maximum torque possible taking into account its small size;
it has a long operational duration;

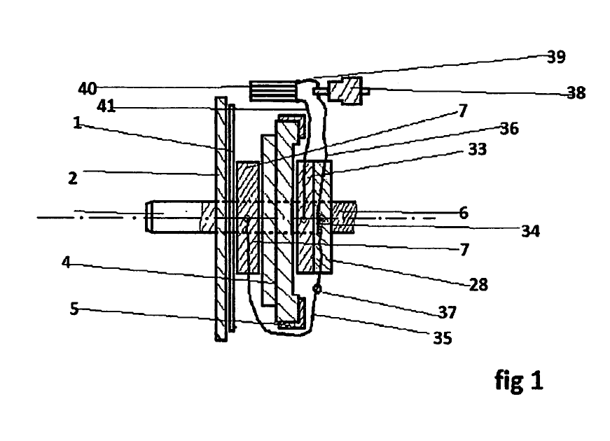

Below is presented an example of execution of this invention also in connection with FIGS. 1 to 3 which show respectively:

FIG. 1, general view of the ball hydraulic clutch according to the invention;

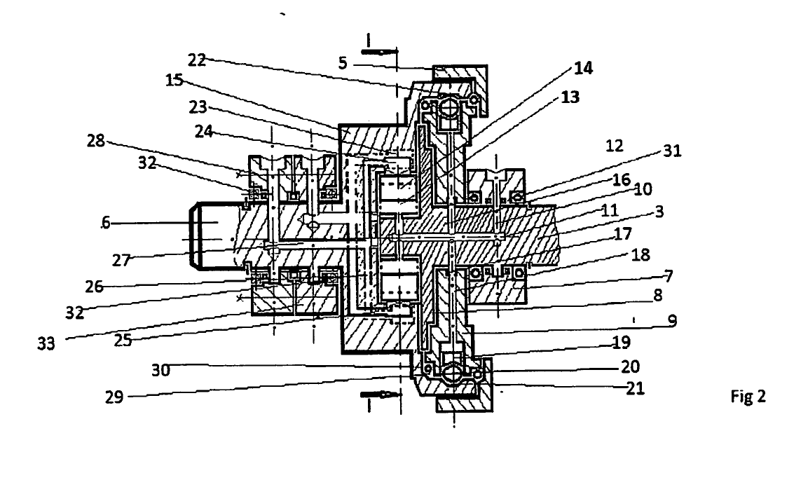

FIG. 2, axial section through FIG. 1;

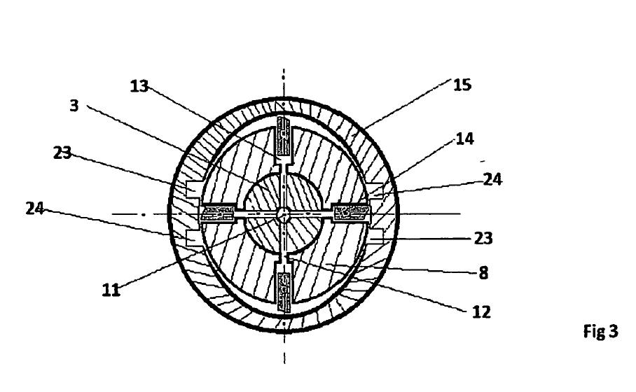

FIG. 3, section with a plan I-I from FIG. 2;

The ball hydraulic clutch, according to this invention, includes a metal disc 1 mounted on a flywheel 2 and coupled with a PTO shaft 3, which engages an oil pump 4 closed with a threaded safety ring 5, through which the motor torque is transmitted to a primary shaft 6.

The metal disc 1 has the same configuration like a friction disc in a classical clutch. It is mounted on flywheel 2 with tightening screws, so it ties in with the flywheel. In the hub of the metal disc 1 is coupled PTO shaft 3 on which a pressure chamber 7 is mounted, the PTO shaft 3 being tied in with a rotor 8 and a drum 9.

The PTO shaft 3, the rotor 8 and the drum 9 are provided with link grooves through which pressure oil passes. The oil is in a closed circuit, flowing through the pressure chamber 7, through a radial groove 10 and an axial groove 11 of the PTO shaft 3, and from there through some radial grooves 12 on the rotor 8 corresponding to some radial rectangular seats 13, each located on axial blades 14 which are pushed by the oil onto the inside surface of the stator 15.

The axial groove 11 corresponds to a radial groove 16, through which the pressure oil is supplied to the drum 9, where it gets into a circular groove 17 and from there to some radial grooves 18. Inside each of these there are, freely placed, some axial pistons 19 and pressure balls 20, which are pressed onto the surface of a circular groove 21, made on some axial bulges 22 on the stator 15.

The stator 15 is tied in with the primary shaft 6 and on the inside, in the section of contact with the axial blades 14, it has an elliptical form, which allows the admission and discharge of the pressure oil through some admission ports 23 and other discharge ports 24.

The oil which is pressed through the discharge port 24 gets into a transverse groove 25, wherefrom into a radial groove 26, corresponding to the axial grooves 27 on the primary shaft 6 and a high pressure chamber 28 mounted on the primary shaft 6. Also, the stator 15 is provided with some seats 29 into which the radial bearings 30 with thin rings sit. The bearings are mounted on the ball drum 9, thus allowing the independent rotation of both the rotor 8 and the stator 15. Also, the PTO shaft 3 sits on a bearing which (not represented and known per se), which generally exists inside flywheel 2 or the driving shaft, as well as on some radial bearings 31 of the pressure chamber 7.

The primary shaft 6 sits on a bearing (not represented) which generally exists on primary shafts and on the radial bearings 32 of the high pressure chamber 28 and of a low pressure chamber 33.

The three pressure chambers, 7, 28 and 33, are equipped with oil-sealing rings which isolate the oil from the exterior within these chambers and ensure the air-tightening of the chambers.

Back to the high pressure chamber 28, on it is mounted an element 34 with two oil passage circuits, to which the high pressure pipes 35 and 36 are attached. A passage solenoid valve 37 is attached to the pipe 35 and is connected to the pressure chamber 7, while the pipe 36 is attached to a pressure regulator 38 which, in its turn, is connected through a low pressure pipe 39 to an oil cooling radiator 40. From here the oil is supplied through a low pressure pipe 41 to the low pressure chamber 33 installed on the primary shaft 6. The two pressure chambers, 28 and 33, are tied in, being, assembled with tightening screws (not positioned), but they have separate circuits.

The oil in the low pressure chamber 33 goes through the stator 15 following the same route, but is separated from the hydraulic oil, reaching the admission port 23.

When the flywheel 2 engages the rotation and transmits the power torque through the PTO shaft 3 which, due the centrifugal force, rotates the rotor 8 as well as the ball drum 9, the axial blades 14 come out of the radial rectangular seats 13, aspiring the oil from the admission port 23 and force it under pressure through the discharge port 24 and through the stator grooves 15 towards the high pressure chamber 28. From here the oil gets to the passage solenoid valve 37 and implicitly to the pressure regulator 38 which closes the circuit progressively depending on the setting at the required pressure, depending on the power torque it receives from the PTO shaft 3.

Back to the passage solenoid valve 37 which allows the passage of the hydraulic oil to the pressure chamber 7 and through the grooves of the PTO shaft 3, the oil reaches the rotor 8 of the pump, providing an adequate pressure under the axial blades 14 and at the same time the pressure required by the radial pistons 19, which press the pressure balls 20 which run on the circular groove 21.

When the pressure of the oil increases, in the elliptical space between the rotor 8 and the stator 15, meeting resistance to its advance, the oil opposes to the axial blades 14 or the rotor 8, which engage progressively the stator 15 into rotation. When the speed of the rotor 8 equals the speed of the stator 15, the passage solenoid valve 37, at the command of a computer (not represented), closes the circuit of the oil to the ball drum 9, leaving under pressure the radial pistons 19 and the pressure balls 20 which sit into the circular groove 21 of the stator 15, thus achieving a rigid coupling between the rotor 8 and the stator 15.

At the command of the computer, the solenoid valve 37 opens and releases the hydraulic oil from the drum 9 and implicitly the uncoupling of the rotor 8 from the stator 15.

1. Hydraulic clutch bearing, characterised through the fact that it is made up of a metal disc (1) coupled with a flywheel (2) of the engine, a PTO shaft (3) coupled with the metal disc (1) and tied in with the rotor (8) of a hydraulic pump (4) and a pressure chamber (7) mounted on the PTO shaft (3). Inside the hydraulic pump (4) there is a ball drum (9) tied in with the rotor (8) of the pump and in gear, through blocking, with the stator (15) of the pump, which is tied in with the primary shaft (6) on which are mounted a low pressure chamber (33) and a high pressure chamber (28). The high pressure chamber (28) is connected to a pressure regulator (38) and, through a solenoid valve (37) to the chamber pressure (7) on the PTO shaft (3), the pressure regulator (38) being attached to an oil cooling radiator (40) which, in its turn, is connected to the low pressure chamber (33).

2. Hydraulic clutch bearing characterised, according to claim 1 above, through the fact that the pump rotor (8) is provided with radial rectangular seats (29) into which slide some metal blades (14) and radial grooves (12) which are in connection with an axial groove (11) and a radial groove (19), corresponding to the pressure chamber (7) on the PTO shaft (3), the axial groove (11) corresponding to a circular groove (17) and to the radial grooves (18) on the drum. There are balls (20) pressing on a circular groove (21) with bulges on the stator (15). The stator is equipped with admission ports (23) which correspond to the cross grooves (25) and the radial grooves (26), but also to the axial grooves (27) on the primary shaft (6). These grooves make the connection with the high pressure chamber (28) and the low pressure chamber (33). On the outside the stator (15) is provided with a threaded section on which a threaded securing ring (5) is attached, which regulates the distance between the rotor (8) and the stator (15), as well as the tightening of the bearings inside the hydraulic pump (4).
